(19) United States
(12) Patent Application Publication
(10) Pub. No.: US 2006/0020902 A1
(43) Pub. Date: Jan. 26, 2006

(54) Interactive graphical user interfaces for computer display systems with simplified implementation for exposing completely hidden windows

(75) Inventor: Timur Tabi, Austin, TX (US)

Correspondence Address: IBM CORPORATION;INTELLECTUAL PROPERTY LAW, 11400 BURNET ROAD, AUSTIN, TX, 78758, US

(73) Assignee: International Business Machines Corporation, Armonk, NY (US)

(21) Appl. No.: 10/896,501

(22) Filed: Jul. 22, 2004

(51) Int. Cl. G06F 3/00

(52) U.S. Cl. 715/790; 715/793

(57) ABSTRACT

Displaying on a display screen at least a portion of each of a set of windows initially completely hidden within said stack. Defining each hidden window in the stack of windows and mapping for each hidden window the collective perimeter of all of the windows in the stack above the hidden window. A user is enabled to input a display hidden windows command and, responsive to the “display hidden windows” command, each hidden window in an orthogonal direction until a least a portion of the moved hidden window extends beyond the collective perimeter of the windows above said moved window. For ease of use, the display hidden windows command may be an item, e.g. icon on the display screen. If the hidden window has a border region, as described above, identifying the window, then the means for moving the window preferably moves the window in an orthogonal direction whereby this identifying border extends beyond said collective perimeter on said display screen.

### TECHNICAL FIELD

The present invention relates to user interactive computer supported display technology and particularly to windows-type graphical user interfaces having stacks of overlapped windows.

### BACKGROUND OF RELATED ART

The past decade has been marked by a technological revolution driven by the convergence of the data processing industry with the consumer electronics industry. This advance has been even further accelerated by the extensive consumer and business involvement in the Internet or World Wide Web (Web) (used interchangeably). As a result of these changes, it seems as if virtually all aspects of human endeavor in the industrialized world require human-computer interfaces. There is a need to make computer directed activities accessible to a substantial portion of the world's population, which, up to a few years ago, was computer indifferent. In order for the vast computer supported marketplaces to continue and be commercially productive, it will be necessary for a large segment of computer indifferent consumers to be involved in computer interfaces.

With the increasing power of computers, functions and resources available to the interactive user have greatly increased. However, along with this increase in function has come a significant increase in the number and variety of windows available to the user in a display screen interface. This, of course, makes the interface much more complex with tens, and potentially hundreds, of available windows that contain the interactive data items, such as icons. These are arranged in stacks of overlapping windows, the display of which is controlled and tracked through a multi-tiered display or frame buffer, such as the depth buffers described in U.S. Pat. No. 5,241,656.

In fact, the multi-tiered hierarchy of windows has become so extensive that they often are arranged in a plurality of desktop session levels. A desktop session is usually made up of several layers of overlapping windows that the depth frame buffer indexes and tracks. In addition, window interfaces are set up to handle additional desktop sessions of layered windows that are inactive and stored outside of the frame buffer, but may be interactively moved into and out of the frame buffer as the sessions are activated. With such a complex arrangement, it will be obvious that at any given time a number of windows will be wholly hidden by overlapping windows.

When windowing environments were originally developed, the interactive user had to deal with no more than a handful of windows. From that time on, it became customary to identify each window with a title bar including the name or title of the window. With so few windows, even if there was some overlap, it was simple for the user to shift a window with his cursor so as to expose the title bar and identify the window. At the present time, with the number and the complicated hierarchies of windows described above, it is often a tedious and difficult task for the user to shift or drag the displayed windows to expose enough of the title bars or even other portions of windows sufficient to identify the completely hidden windows. For example in some windows operating systems, an identifying item for each opened window on the display screen is placed in the screen title bar at the top or bottom of the screen. The user may then peruse this item bar to determine whether there may be items representing hidden windows that the user may be interested in. In such a case, the user may click on the item with a mouse pointer to cause the hidden window to jump to the top of the stack. Such an operation requires sufficient computer skill on the part of the user to peruse the small items on the list and to then connect the item with a window of interest. Also, as the number of windows grows, this results in an increase in the number of windows to the point that even experienced computer users would have difficulty in relating listings in this item bar to hidden windows. In addition, selectively moving hidden windows to the top of the stack changes the ordering in the Z-display buffer, which may be somewhat disruptive to the window operating process.

Other schemes for exposing hidden windows involve tiling wherein all of the overlapping windows in a stack are dispersed in response to a user input command into a two-dimensional array wherein every window is appropriately sized and laid out. Of course, this can be very disruptive to the above-described ordering in the Z-buffer.

### SUMMARY OF THE PRESENT INVENTION

The present invention offers an implementation to simplify such exposure and identify hidden windows so that there will be ease of use for even the unsophisticated computer user. The invention provides a user friendly display interface system for the interactive handling and sorting out of windows in complex window hierarchical graphical user interfaces. The system provides for displaying on a display screen at least a portion of each of a set of windows initially completely hidden within the stack that comprises defining each hidden window in the stack of windows, mapping for each hidden window the collective perimeter of all of the windows in the stack above the hidden window, enabling a user to input a display hidden windows command and responsive to the “display hidden windows” command, moving each hidden window in an orthogonal direction until at least a portion of the moved hidden window extends beyond the collective perimeter of the windows above said moved window. For ease of use, the display hidden windows command may be an item, e.g. icon on the display screen. If the hidden window has a border region, as described above, identifying the window, then the means for moving the window preferably moves the window in an orthogonal direction whereby the border extends beyond said collective perimeter on said display screen.

In accordance with an aspect of this invention, it is recognized that the collective perimeter of all windows in the stack above the hidden window may extend beyond the edge of the display screen or so close to the edge, that orthogonal movement in a given direction approaching such an edge will not sufficiently expose the hidden window. In such a situation, the invention provides for the selection of another direction that will result in sufficient exposure of the hidden window. Where there are a plurality of such hidden windows to be moved, it may be preferable to orthogonally move such windows in directions different from each other.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a block diagram of an interactive data processor controlled display system including a central processing unit that is capable of implementing the hidden windows exposure implementation of the present invention;

FIG. 2 is a diagrammatic view of a display screen showing a stack or hierarchy of windows that will be used to illustrate the present invention of exposing two hidden windows;

FIG. 3 is the simplified diagrammatic view of the display screen of FIG. 2 showing one of the hidden windows and the portion of the stack of windows above this one hidden window;

FIG. 4 is the diagrammatic view of FIG. 3 but showing the movement to expose the one hidden window;

FIG. 5 is the simplified diagrammatic view of the display screen of FIG. 2 showing another of the hidden windows and the portion of the stack of windows above this other hidden window;

FIG. 6 is the diagrammatic view of FIG. 5 but showing the movement to expose the other hidden window;

FIG. 7 is a flowchart of the program steps involved in setting up the hidden window exposure and identification system of the present invention; and

FIG. 8 is a flowchart of an illustrative running of the steps set up in the program of FIG. 7.

### DETAILED DESCRIPTION OF THE PREFERRED EMBODIMENT

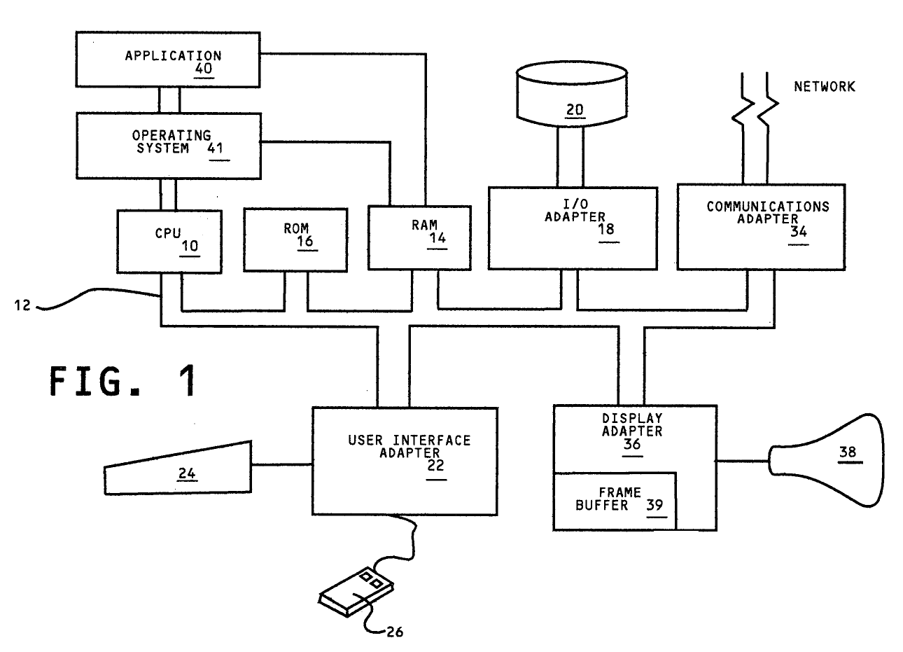

Referring to FIG. 1, a typical data processing system is shown that may function as the computer controlled display terminal used in implementing the system of the present invention of exposing at least portions of completely hidden windows. A central processing unit (CPU) 10, such as one of the PC microprocessors or workstations, e.g. RISC System/6000™ series available from International Business Machines Corporation (IBM), or Dell PC microprocessors, is provided and interconnected to various other components by system bus 12. An operating system 41 runs on CPU 10, provides control and is used to coordinate the function of the various components of FIG. 1. Operating system 41 may be one of the commercially available operating systems, such as IBM's AIX 6000™ operating system or Microsoft's WindowsXP™ or Windows2000™, as well as UNIX and other IBM AIX operating systems. Application programs 40, controlled by the system, are moved into and out of the main memory Random Access Memory (RAM) 14. These programs include the programs of the present invention for the generation and manipulation of stacked windows on an interactive display interface to expose any completely hidden windows that will be described hereinafter. A Read Only Memory (ROM) 16 is connected to CPU 10 via bus 12 and includes the Basic Input/Output System (BIOS) that controls the basic computer functions. RAM 14, I/O adapter 18 and communications adapter 34 are also interconnected to system bus 12. I/O adapter 18 may be a Small Computer System Interface (SCSI) adapter that communicates with the disk storage device 20. Communications adapter 34 interconnects bus 12 with an outside Internet or Web network. I/O devices are also connected to system bus 12 via user interface adapter 22 and display adapter 36. Keyboard 24 and mouse 26 are all interconnected to bus 12 through user interface adapter 22. It is through such input devices that the user may interactively relate to the programs of this invention. Display adapter 36 includes a frame buffer 39, which is a storage device that holds a representation of each pixel on the display screen 38. Images may be stored in frame buffer 39 for display on monitor 38 through various components, such as a digital to analog converter (not shown) for CRTs and the like for digital displays, e.g. LCD displays. As previously mentioned, in order to accommodate the hierarchies of overlapping and hidden windows, the frame buffer 39 should be a depth buffer, for example the depth buffer of U.S. Pat. No. 5,241,565. By using the aforementioned I/O devices, a user is capable of inputting information to the system through the keyboard 24 or mouse 26 and receiving output information from the system via display 38.

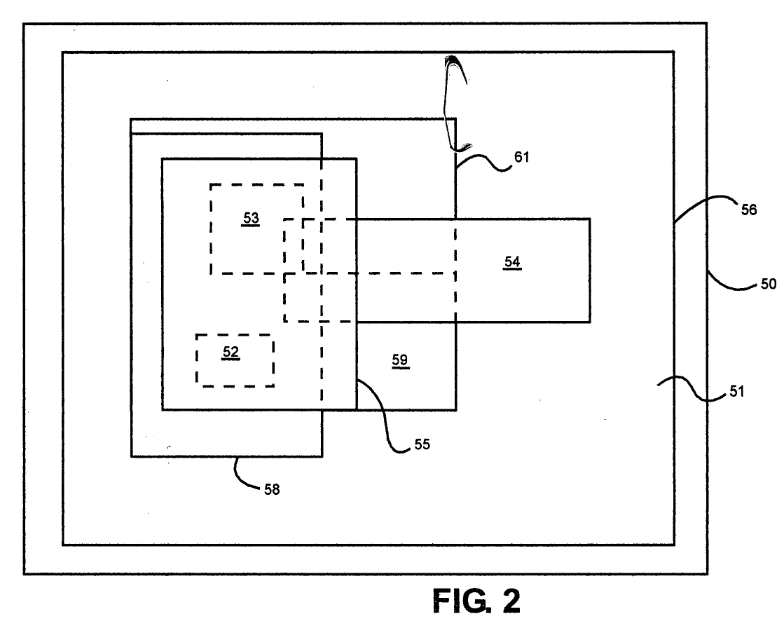

There will now be described a simple illustration of the present invention with respect to the display screens of FIGS. 2 through 6. When the screen images are described, it will be understood that these may be rendered by storing image and text creation programs, such as those in any conventional window operating system in RAM 14 of the system of FIG. 1. The operating system is diagrammatically shown in FIG. 1 as operating system 41. The display screens of FIGS. 2 through 6 are presented to the viewer on display monitor 38 of FIG. 1. In accordance with conventional techniques, the user may control the screen interactively through a conventional I/O device, such as mouse 26 of FIG. 1, which operates through user interface 22 to call upon programs in RAM 14 cooperating with the operating system 41 to create the images in frame buffer 39 of display adapter 36 to control the display on monitor 38. The windows-type operating system 41 conventionally has a windows manager that controls the stack of windows, and tracks the orthogonal definition of each window and its orthogonal location, as well as the location of the window in the Z-buffer, i.e. the depth position in the stack.

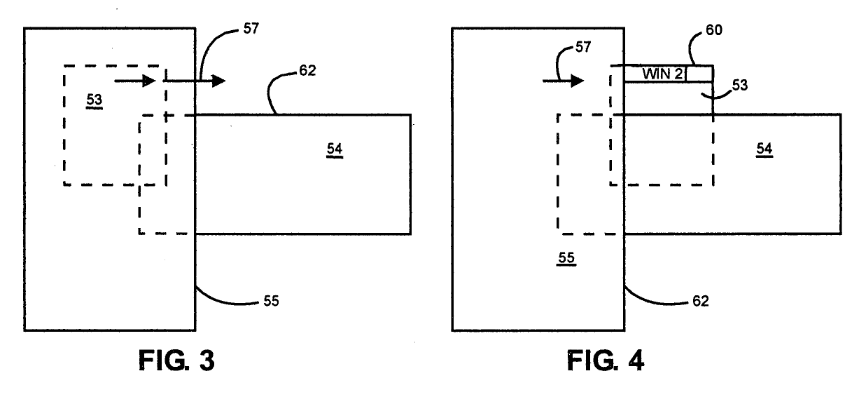

With reference to FIG. 2, a hierarchy or stack of overlapping windows, two (windows 52 and 53) that are completely hidden, occupies the screen. For convenience of illustration, objects or icons and text have been removed from windows. The remaining partially visible windows in the stack are windows 54, 55, 58 and 59. Although, the depth buffer is not shown, we will assume that hidden window 52 is lowermost, i.e. at the bottom of the stack, and thus covered by the full collective perimeter 61 of all of the windows in the stack while hidden window 53 is at a stack level where it is covered only by windows 54 and 55 that have a more limited collective perimeter 62 as shown in FIG. 3. An orthogonal direction may be chosen at random, e.g. direction 57, FIG. 3, and the window 53 is moved that direction by a conventional mouse controlled pointer until a portion of hidden window 53 is exposed as shown in FIG. 4. For best results, and will hereinafter be described, the direction may be chosen to ensure that an identifying region 60 for the window 53 is exposed.

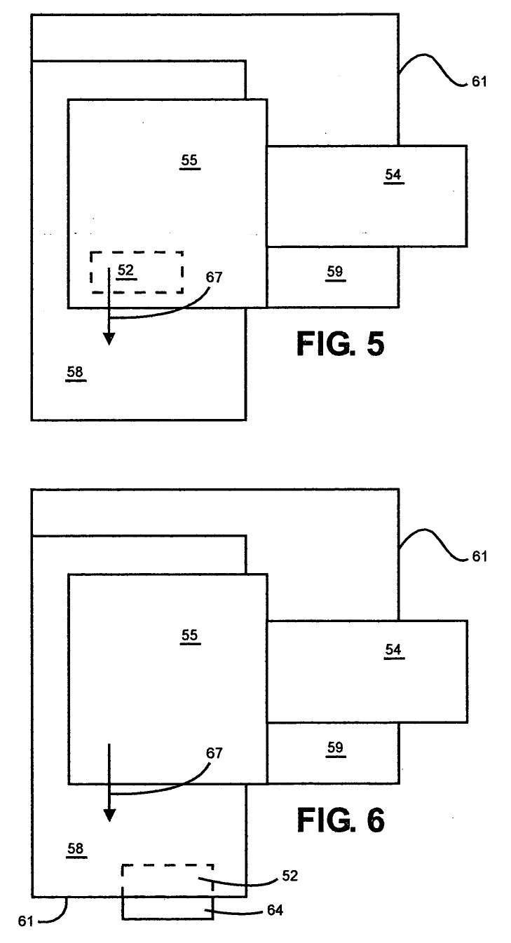

Now with reference to FIGS. 5 and 6, hidden window 52 is at the bottom of the stack where it is covered by all of the other windows in the stack, and thus has the full collective perimeter 61 of the stack to traverse before it is exposed. Thus, for example, the window is moved in direction 67 until the window 52 crosses collective perimeter 61 and has an exposed portion 64.

Again with respect to FIG. 2, it should be noted that unlike the stack of windows shown, another stack of windows could contact or be so close to edge 56 of display 50 screen 51 that if a hidden window were to be moved in the orthogonal direction toward that close edge 56 of screen 51, there could be little or no significant exposing of any portion of the hidden window. In such a case, if the user were to randomly choose an orthogonal path to such a close edge, the window manager would advise the application of the present invention, the user would be prohibited from moving the window in that direction and prompted on the screen to select another orthogonal direction.

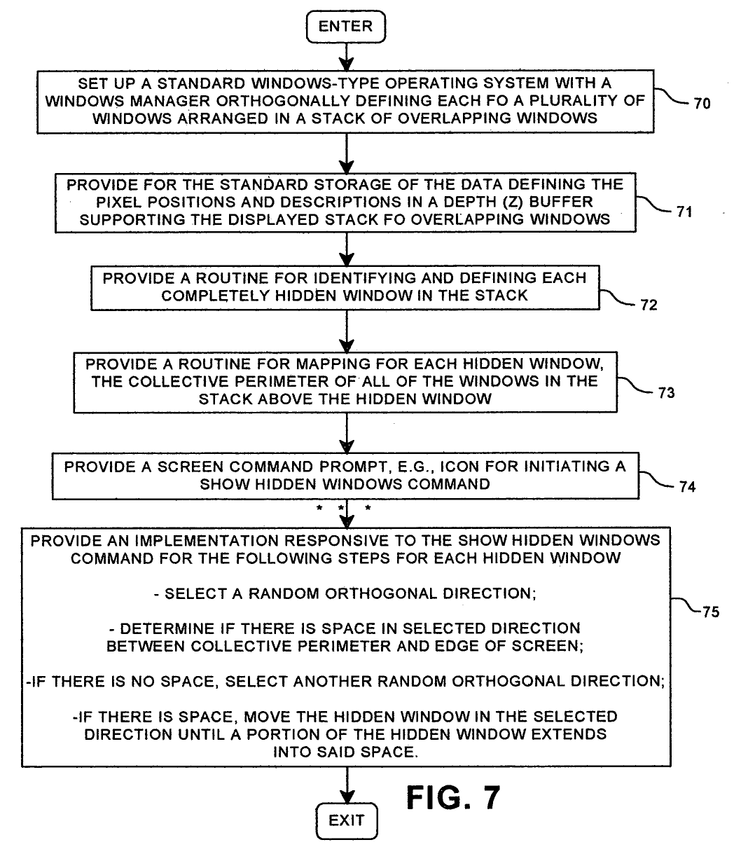

Now with reference to FIG. 7, we will describe a process implemented by a program according to the present invention for exposing at least some portions of completely hidden windows in a window hierarchy stack. The program routines created by the process of FIG. 7 implement the operations described with respect to FIGS. 2 through 6. In the flowchart of FIG. 7, a basic type operating system is set up, step 70, using any operating system for managing a hierarchy of windows, e.g. Windows Millennium™, and Motif for Unix or AIX to orthogonally define the overlapping windows in the stack and the positions of the windows in the depth levels of the hierarchy. This is accomplished by standard storage of data defining the pixel descriptions and orthogonal positions in a depth or Z-buffer to support a stack of overlapping windows, step 71. Using the operating system window manager, a routine is provided for defining each completely hidden window in the stack, step 72. A routine is provided for mapping for each hidden window in the stack and the collective perimeter of all of the windows in the stack above the hidden window, step 73. An on-screen prompt, such as an icon, is provided for commencing a show hidden windows command, step 74.

A routine is provided, step 75, in response to a show hidden windows command that would carry out the following routine:
Select an orthogonal direction at random;
Determine if there is space in the selected direction between collective perimeter and the edge of screen;
If No, space select another orthogonal direction;
If there is such space, move the hidden window in the selected direction until a portion of the hidden window extends into the space.

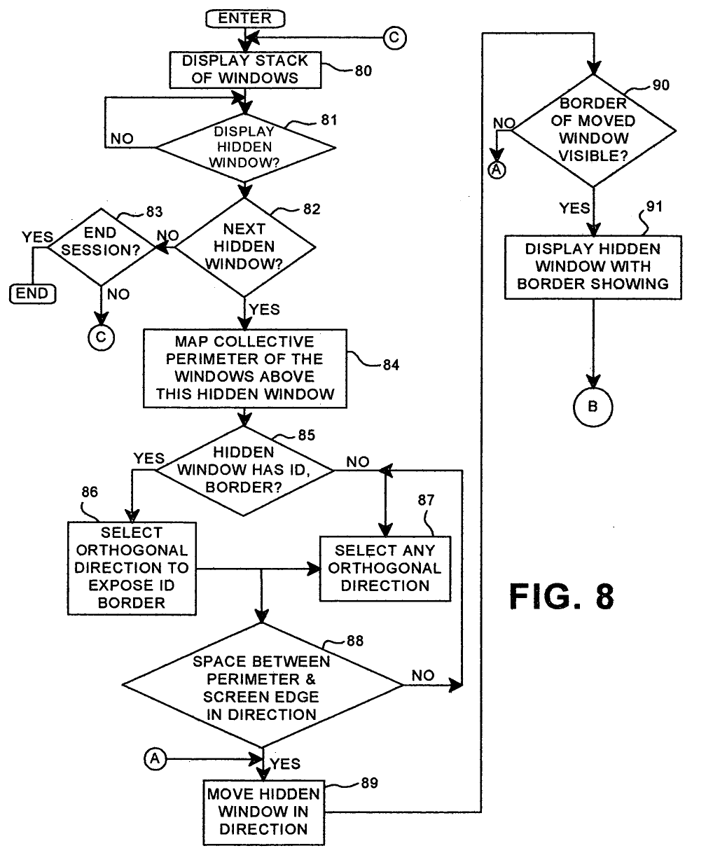

Now that the basic program has been described and illustrated, there will be described with respect to FIG. 8 a simple operation showing how the program could be run. A stack of windows is displayed, step 80. A determination is made, step 81, as to whether the user has activated the display hidden windows command. If No, the process is returned to decision step 81 and such a command is awaited. If Yes, there is such a command, step 82, a determination is made as to whether there is such a first or next hidden window to be displayed. If Yes, the collective perimeter of all of the windows in the stack above the hidden window is mapped, step 84, after which a determination is made as to whether the hidden window has any identifying border, step 85. If Yes, then an orthogonal direction is chosen that would expose such a border, step 86. If No, then any other orthogonal direction is chosen, step 87. After step 86 or 87, a further determination is made as to whether there is space between the collective perimeter and the edge of the screen in the direction selected, step 88. If No, the process is returned to step 87 and the process continued as described above. If Yes, the hidden window is moved in the selected direction, step 89, while a determination is continually made, step 90, as to whether the border or significant edge of the moved hidden window has been exposed. If No, the process is returned to step 89 via branch A, and the process continues to be monitored in step 90. If the determination at step 90 is Yes, the hidden window, preferably with its identifying border, is exposed, step 91, and the process is returned to decision step 82 via branch B and another determination is made as to whether there is another hidden window. If Yes, then the process continues as described above. If No, a determination is made, step 83, as to whether the session is over. If Yes, the session is exited. If No, the process is returned via branch C to step 80 wherein the user may continue to interface with and use the stacked windows.

One of the preferred implementations of the present invention is as a routine in an operating system made up of programming steps or instructions resident in RAM 14, FIG. 1, during computer operations. Until required by the computer system, the program instructions may be stored in another readable medium, e.g. in disk drive 20, or in a removable memory, such as an optical disk for use in a CD ROM computer input or in a floppy disk for use in a floppy disk drive computer input. Further, the program instructions may be stored in the memory of another computer prior to use in the system of the present invention and transmitted over a local area network (LAN) or a wide area network (WAN), such as the Internet, when required by the user of the present invention.

One skilled in the art should appreciate that the processes controlling the present invention are capable of being distributed in the form of computer readable media of a variety of forms.

Although certain preferred embodiments have been shown and described, it will be understood that many changes and modifications may be made therein without departing from the scope and intent of the appended claims.

What is claimed is:

1. In a computer controlled interactive display system comprising a stored hierarchy of windows that are displayable to overlap each other in a selected order to form a displayed stack of windows, a system for displaying on a display screen at least a portion of each of a set of said windows initially completely hidden within said stack comprising:
means for defining each hidden window in said stack of windows;
means for mapping for each hidden window the collective perimeter of all of the windows in said stack above said hidden window;
means enabling a user to input a display hidden windows command; and
means responsive to said display hidden windows command for moving each hidden window in an orthogonal direction until a least a portion of the moved hidden window extends said collective perimeter of the windows above said moved window.

2. The system for displaying hidden windows of claim 1 wherein said means enabling said display hidden windows command is an item on said display screen.

3. The system for displaying hidden windows of claim 2 wherein said item enabling the display hidden windows command is an icon.

4. The system for displaying hidden windows of claim 2 wherein:
said hidden window has a border region identifying the window; and
said means for moving said window moves said window in an orthogonal direction whereby said border extends beyond said collective perimeter on said display screen.

5. The system for displaying hidden windows of claim 1, wherein:
said means for moving each window includes:
means for randomly selecting an orthogonal direction; and
means for preventing said orthogonal movement if said orthogonal movement would reach an edge of said display screen before reaching said collective perimeter.

6. The system for displaying hidden windows of claim 5, wherein said means for moving each window move a plurality of said windows each in a direction different from the direction of movement of the other windows in said plurality of windows.

7. In a computer controlled interactive display system comprising a stored hierarchy of windows that are displayable to overlap each other in a selected order to form a displayed stack of windows, a method for displaying on a display screen at least a portion of each of a set of said windows initially completely hidden within said stack comprising:
defining each hidden window in said stack of windows;
mapping for each hidden window the collective perimeter of all of the windows in said stack above said hidden window;
enabling a user to input a display hidden windows command; and
in response to said display hidden windows command, moving each hidden window in an orthogonal direction until at least a portion of the moved hidden window extends said collective perimeter of the windows above said moved window.

8. The method for displaying hidden windows of claim 7 wherein said command of displaying hidden windows is enabled through selecting an item on said display screen.

9. The method for displaying hidden windows of claim 8 wherein said item enabling the display hidden windows command is an icon.

10. The method for displaying hidden windows of claim 8:
wherein one of said hidden windows has a border region identifying the window; and
said step of moving said window moves said window in an orthogonal direction whereby said border extends beyond said collective perimeter on said display screen.

11. The method for displaying hidden windows of claim 7:
wherein said step of moving each window includes:
randomly selecting an orthogonal direction; and
preventing said orthogonal movement if said orthogonal movement would reach an edge of said display screen before reaching said collective perimeter.

12. The method of displaying hidden windows of claim 11, wherein said step of moving each window moves a plurality of said windows each in a direction different from the direction of movement of the other windows in said plurality of windows.

13. A computer program having code recorded on a computer readable medium for displaying on a display screen at least a portion of each of a set of windows initially completely hidden within a computer controlled interactive display system comprising a stored hierarchy of windows that are displayable to overlap each other in a selected order to form a displayed stack of windows, said computer program comprising:
means for defining each hidden window in said stack of windows;
means for mapping for each hidden window the collective perimeter of all of the windows in said stack above said hidden window;
means enabling a user to input a display hidden windows command; and
means responsive to said display hidden windows command for moving each hidden window in an orthogonal direction until at least a portion of the moved hidden window extends said collective perimeter of the windows above said moved window.

14. The computer program for displaying hidden windows of claim 13 wherein said means enabling said display hidden windows command is an item on said display screen.

15. The computer program for displaying hidden windows of claim 2 wherein said item enabling the display hidden windows command is an icon.

16. The computer program for displaying hidden windows of claim 14:
wherein a hidden window has a border region identifying the window; and
said means for moving said window moves said window in an orthogonal direction whereby said border region extends beyond said collective perimeter on said display screen.

17. The system for displaying hidden windows of claim 1:
wherein said means for moving each window includes:
means for randomly selecting an orthogonal direction; and
means for preventing said orthogonal movement if said orthogonal movement would reach an edge of said display screen before reaching said collective perimeter.

18. The computer program for displaying hidden windows of claim 17, wherein said means for moving each window move a plurality of said windows each in a direction different from the direction of movement of the other windows in said plurality of windows.
